(19) United States
(12) Patent Application Publication
(10) Pub. No.: US 2007/0178425 A1
(43) Pub. Date: Aug. 2, 2007

(54) ADJUSTABLE DENTAL BITE FORK

(75) Inventors: Carl F. Driscoll, Columbia, MD (US); Charlson Choi, Baltimore, MD (US)

Correspondence Address: BARNES & THORNBURG LLP, P.O. BOX 2786, CHICAGO, IL, 60690-2786, US

(73) Assignee: UNIVERSITY OF MARYLAND, BALTIMORE, Baltimore, MD (US)

(21) Appl. No.: 11/622,351

(22) Filed: Jan. 11, 2007

Related U.S. Application Data
(60) Provisional application No. 60/758,585, filed on Jan. 12, 2006.

(51) Int. Cl. A61C 19/04

(52) U.S. Cl. 433/73

(57) ABSTRACT

An adjustable bite fork that includes first and second wing portions, each having a front member defining an opening, and a leg portion extending from the front portion to a first end distal to the front portion, wherein the openings of the wing portions are aligned in registry with one another and an adjustable connection member extends through the openings; and a method for aligning a cast of a patient's maxillary jaw on an articulator is also disclosed.

### CROSS-REFERENCE TO RELATED APPLICATIONS

This patent application claims the benefit of U.S. Provisional Patent Application No. 60/758,585, filed Jan. 12, 2006, the content of which is incorporated herein by reference in its entirety.

### FIELD OF THE INVENTION

This invention pertains to a dental apparatus and, in particular, to an adjustable bite fork.

### BACKGROUND OF THE INVENTION

A bite fork is used to record the position of the maxilla in a patient in order to transfer this position to a cast on an articulator, which is used to mimic the movements of a patient. Conventional bite forks are sized to fit an average-sized mouth. Of course, not all patients have an average-sized mouth. This is especially true of children and adults with microstomia (i.e., small mouths).

When attempting to align a cast of the maxilla of a patient having a smaller than average mouth size using the standard-size bite fork, the assistant must guess where the maxilla should be. For this reason, an adjustable bite fork that can be adjusted to fit in a smaller than average mouth would be an important improvement in the art. It is also an object of the present invention to produce such a bite fork. This and other objects and advantages, as well as inventive features, will become apparent from the detailed description provided herein.

### BRIEF SUMMARY OF THE INVENTION

The invention is directed to an adjustable dental bite fork comprised of a first wing section having a front member defining a first opening, and a leg portion extending from the front portion to a first end distal to the front portion. A second wing section has a front member that defines a second opening, and a leg portion extends from the front portion to a first end distal to the front portion. The second opening is in registry with the first opening such that the first end of the leg portion of the first wing section is separated from the first end of the leg portion of the second wing section by a first distance, and an adjustable connection member extending through the first and second openings, thereby allowing the first ends of the leg portions to be separated by a variety of distances that may be less or greater than the first distance.

The invention also involves a method for aligning a maxillary cast of a patient on an articulator, the method comprised of: (a) forming a maxillary cast of a patient's mouth; (b) loosening a connection member joining a first wing section and a second wing section of the bite fork together; (c) separating a distance between a first end of the first wing section and a first end of the second wing section so as to align the wing sections with the maxillary jaw; (d) obtaining registration of the maxillary teeth; (e) attaching the aligned bite fork to the articulator; and (f) positioning the maxillary cast on the bite fork.

### BRIEF DESCRIPTION OF THE DRAWINGS

FIG. 1 is a top view of a particular type of a non-adjustable bite fork that is known in the art.

FIG. 2 is a top view of a second type of a non-adjustable bite fork that is known in the art.

FIG. 3 is a top view of an adjustable bite fork in accordance with the present invention in an extended position.

FIG. 4 is a top view of an adjustable bite fork in accordance with the present invention in a retracted position.

FIG. 5 is a top view of a standard bite fork aligned with a cast of a maxilla of a patient having a smaller than average mouth.

FIG. 6 is a top view showing the adjustable bite fork positioned within a cast of a maxilla of a patient having a smaller than average mouth.

### DETAILED DESCRIPTION OF THE INVENTION

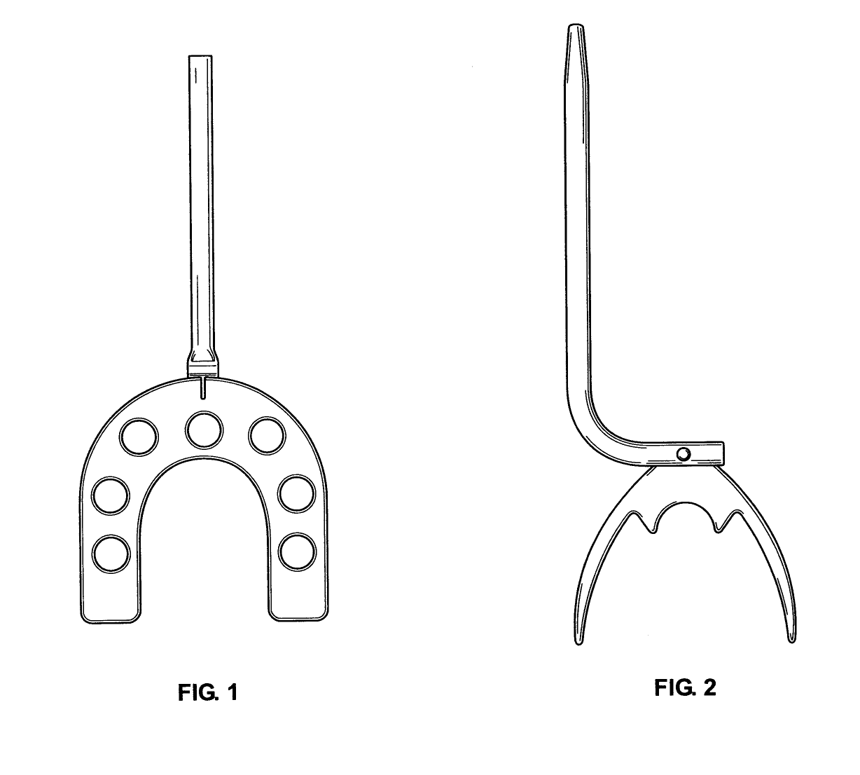

FIGS. 1 and 2 show conventional bite forks in which the wings of the bite fork are permanently positioned at a given distance from one another. FIG. 5, shows how the cast of the maxilla of a patient having a smaller than average mouth size does not align with a standard bite fork on an articulator.

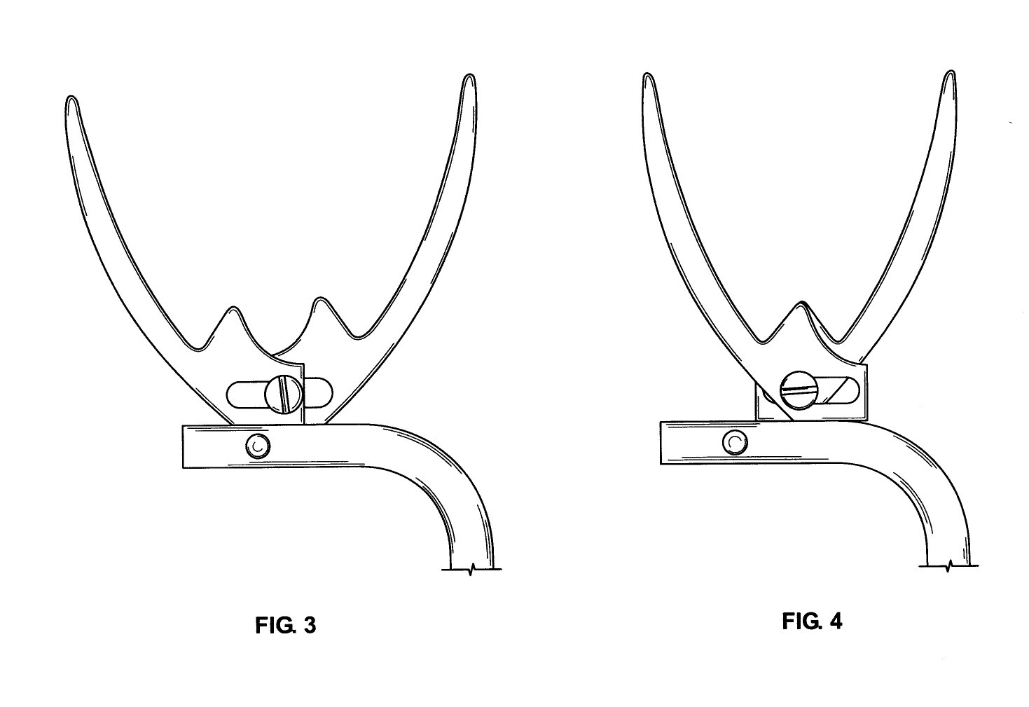

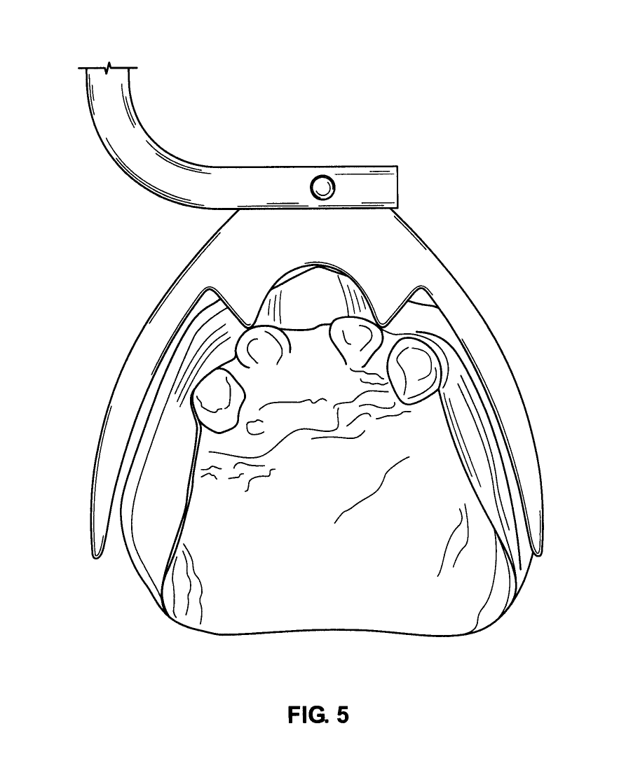

As shown in FIGS. 3, 4, and 6, the invention is directed to an adjustable dental bite fork comprised of a first wing section having a front member defining a first opening, and a leg portion extending from the front portion to a first end distal to the front portion. A second wing section has a front member that defines a second opening, and a leg portion extending from the front portion to a first end distal to the front portion. The second opening is in registry with the first opening such that the first end of the leg portion of the first wing section is separated from the first end of the leg portion of the second wing section by a first distance. A an adjustable connection member extends through the first and second openings, thereby allowing the first ends of each leg portion to be separated by a second distance that is less than the first distance.

In one embodiment of the invention, the first and second openings are each an elongated slot. The connection member that extends through the openings applies friction sufficient to maintain the relative position of the wings. In a particular embodiment, the connection member is a screw.

In another embodiment, the front member of each wing section includes a planar protrusion. These protrusions are used when using the bite fork to fabricate dentures as the protrusions are heated and stuck into a wax occlusal rim that is used to place the cast of the endentulous patient in the correct relationship on the articulator.

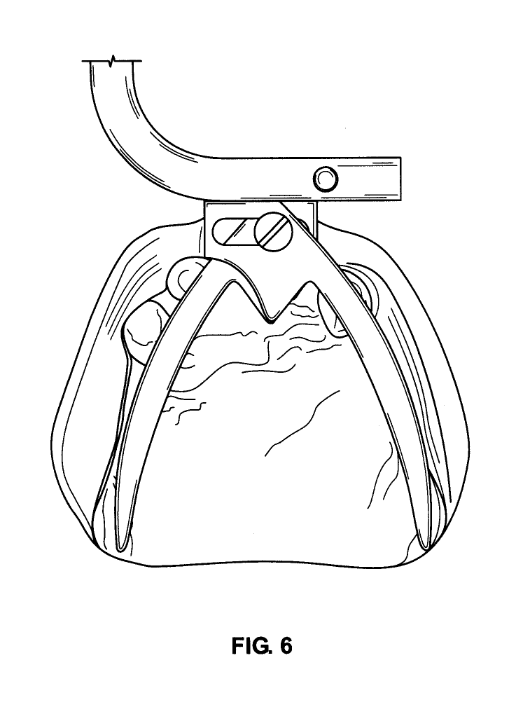

When in use, the dentist or dental assistant has the patient open his/her mouth and then aligns the adjustable bite fork with the patient's jaw from outside of the mouth. This allows the assistant to estimate the width of the patient's mouth. After obtaining this estimate, the assistant loosens the connection member on the bite fork and expands or contracts the distance between the first ends of each wing section, as necessary to accommodate the width of the patient's mouth. The assistant then tightens the connection member and inserts the bite fork into the patient's mouth to confirm the measurement. If necessary, the assistant can once again loosen the connection member and expand or contract the distance between the first ends of the wing sections in order to align more precisely the wings of the bite fork with the patient's jaw. Once the assistant is satisfied with the alignment of the bite fork, registration of the patient's maxillary teeth is obtained. When this is completed, the fork is then attached to the articulator so that the cast of the patient's maxilla can be properly aligned on the articulator as shown in FIG. 6.

The invention also provides a method for placing a maxillary cast of a patient on an articulator. The method is comprised of: (a) forming a maxillary cast of a patient's mouth; (b) loosening a connection member joining a first wing section and a second wing section of a bite fork together; (c) separating a distance between a first end of the first wing section and a first end of the second wing section so as to align the wing sections with the maxillary jaw; (d) obtaining the registration of the patient's maxillary teeth; (d) attaching the aligned bite fork to the articulator; and (e) positioning the maxillary cast on the bite fork.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A dental bite fork comprised of:
a first wing section having a front member defining a first opening, and a leg portion extending from the front portion to a first end distal to the front portion;
a second wing section having a front member defining a second opening and a leg portion extending from the front portion to a first end distal to the front portion;
the second opening in registry with the first opening such that the first end of the leg portion of the first wing section is separated from the first end of the leg portion of the second wing section by a first distance; and
an adjustable connection member extending through the first and second openings, thereby allowing the first ends of the leg portions to be separated by a second distance that is less than the first distance.

2. The dental bite fork of claim 1, wherein the first and second openings are each an elongated slot.

3. The dental bite fork of claim 1, wherein the connection member applies friction sufficient to maintain the relative position of the wings.

4. The dental bite fork of claim 1, wherein the connection member is a screw.

5. The dental bite fork of claim 1, wherein the front member of each wing section includes a planar protrusion.

6. A method for aligning a maxillary cast of a patient on an articulator, the method comprised of:
forming a maxillary cast of a patient's mouth;
loosening a connection member joining a first wing section and a second wing section of a bite fork together;
setting a distance between a first end of the first wing section and a first end of the second wing section so as to align the wing sections with the patient's maxillary jaw;
obtaining a registration of the patient's maxillary teeth;
attaching the aligned bite fork to the articulator; and
positioning the maxillary cast on the bite fork.
